(19) United States
(12) Patent Application Publication
(10) Pub. No.: US 2025/0378668 A1
(43) Pub. Date: Dec. 11, 2025

(54) METHOD AND SYSTEM FOR RECONSTRUCTING THE THREE-DIMENSIONAL SHAPE OF AN OBJECT FROM A MONOCULAR IMAGE

(71) Applicant: IDEMIA Public Security France, Courbevoie (FR)

(72) Inventors: Pierre PERRAULT, Courbevoie (FR); Drazic MARTIN, Courbevoie (FR)

(73) Assignee: IDEMIA Public Security France, Courbevoie (FR)

(21) Appl. No.: 19/093,608

(22) Filed: Mar. 28, 2025

(30) Foreign Application Priority Data
Jun. 7, 2024 (FR) FR2406012

(51) Int. Cl. G06T 19/20; G06T 7/50; G06T 7/73

(52) U.S. Cl. CPC G06T 19/20; G06T 7/50; G06T 7/74; G06T 2207/20081; G06T 2207/20084; G06T 2207/30196; G06T 2219/2016; G06T 2219/2021

(57) ABSTRACT

A method for reconstructing the three-dimensional envelope of an object from a monocular image. The method includes providing a trial three-dimensional envelope of the object by processing the monocular image, obtaining a first modified three-dimensional envelope by applying, to the trial three-dimensional envelope, a first geometric transformation, obtaining a second modified three-dimensional envelope by applying, to the first modified three-dimensional envelope, a second geometric transformation, and obtaining a third modified three-dimensional envelope, by applying, to the second modified three-dimensional envelope, a third geometric transformation.

### TECHNICAL FIELD

The present invention relates to a method and a system for reconstructing the three-dimensional shape of an object from a monocular image.

### TECHNICAL BACKGROUND

It is common practice to detect and count individuals forming a crowd in communal spaces open to the public such as streets, stations, airports, squares, forums, pilgrimage sites, exhibition sites, concert halls and rooms in which other events are hosted. Detecting and counting individuals in this way in particular allows a certain number of means to be implemented, for the purposes of gathering information, of organization, of providing facilities and of logistics. These means range, for example, from simple journalistic reporting (audience measurement) to administrative or police-related public safety and security measures, through regulation of site visits or even evacuation of people in the event of an incident. Statistical studies based on these actions may also provide information essential to establishing and/or optimizing plans for evacuation in the event of a fire, designing suitable amenities for the spaces in question or even organizing routes for traffic to streamline crowd movements. They also form a framework for studying, modeling and predicting collective behavior during crowd movements.

Crowds have very diverse densities and spatial distributions, and are generally not homogeneous. They may in particular spread around pieces of furniture, elements of buildings, parts of the landscape such as trees and shrubs, or other objects such as parked or moving vehicles. For example, a crowd may simply consist of a group of scattered pedestrians moving around a street, a dense group of runners or walkers during a marathon or demonstration, or even a group of substantially static individuals during a concert, a festival or in a train-station or airport concourse.

However, beyond simply detecting and counting individuals, having a three-dimensional representation of the individuals of a crowd and of the environment in which the crowd is located may also provide additional information on the arrangement of the individuals with respect to one another, their distribution in the environment, their interactions and their movements. By virtue of a three-dimensional representation, it is possible to make changes in viewing angles in order to reveal details that would otherwise be concealed as a result of perspective effects or obstacles. By way of example, in the case of examination of the circumstances of a misdemeanor, crime or offence, or simply to prevent legally reprehensible acts from being committed, a three-dimensional representation of a crowd may be a means, for judicial authorities, of retrieving evidence or clues usually inaccessible in two-dimensional images.

However, most video-surveillance systems are based on a network of monocular cameras in which each of the monocular cameras is placed so as to cover a different zone of the environment in which a plurality of moving elements or objects, such as individuals or vehicles, are located. Therefore, the difficulty is to reconstruct the three-dimensional shape of these objects from a monocular image. In particular, in the case of human individuals, it is a question of determining human pose and shape (HPS).

Kocabas, Muhammed, et al. (2021), “SPEC: Seeing people in the wild with an estimated camera”, Proceedings of the IEEE/CVF International Conference on Computer Vision, describes a method for estimating HPS by successively applying two neural networks to a monocular image of an individual. The first network is trained to estimate the field of view and pitch and roll angles from the image. The second neural network is trained to concatenate the camera calibration parameters estimated by the first network with features of the image in order to regress the HPS.

Li, Zhihao, et al., (2022), “Cliff: Carrying location information in full frames into human pose and shape estimation”, European Conference on Computer Vision. Cham: Springer Nature Switzerland, describes a method for estimating the HPS from a monocular image employing a neural network based on an HMR architecture. The HMR part of the network takes, as input datum, a cropped image of the individual while information relating to the environment of the individual is extracted from the cropped part of the cropped image and reintroduced into the neural network just after the step of encoding by the HMR part. Lastly, the neural network is configured to project 3D joints onto the original image in order to allow a 2D reprojection loss function to be computed.

Sun, Yu, et al. (2022), “Putting people in their place: Monocular regression of 3D people in depth”, Proceedings of the IEEE/CVF Conference on Computer Vision and Pattern Recognition, describes a method for estimating the HPS of multiple individuals from a monocular image. The method is based on a neural network trained to estimate the 3D translation of all the individuals by combining the view in the image plane with a bird's eye view. The bird's eye view is represented by a heatmap that estimates the probability of an individual being at a certain depth, and an offset map for correcting this depth. The neural network is trained on a set of annotated images specifying the depth of the individuals.

### SUMMARY OF THE INVENTION

### Technical Problem

One drawback of the available methods for estimating the three-dimensional shape and position of objects from a monocular image is their lack of flexibility. If the features or acquisition conditions of a monocular image differ from those of the images on which these methods were trained, it is common for these methods to fail to correctly estimate the three-dimensional shape and position of the objects. This failure is notable when, for example, the position of the camera that acquired the image or variations in scales are unusual. One explanation is the scarcity, or even absence, of a training set containing monocular images representative of all possible configurations and of all possible types of environments.

There is therefore a need for a flexible, simple and robust solution allowing the three-dimensional shape of an object to be reconstructed from a monocular image.

### Technical Solution

According to a first aspect of the invention, a method as described in claim 1 is provided.

According to a second aspect of the invention, a data-processing device comprising means for implementing a method according to the first aspect is provided.

According to a third aspect of the invention, a computer program comprising instructions that, when the program is executed by a computer, cause the latter to implement a method according to the first aspect is provided.

According to a fourth aspect of the invention, a computer-readable storage medium comprising instructions that, when they are executed by a computer, cause the latter to implement a method according to the first aspect is provided.

According to a fifth aspect of the invention, a system for reconstructing the three-dimensional shape of an object from a monocular image is provided.

### BRIEF DESCRIPTION OF THE DRAWINGS

FIG. 1 is a schematic representation of a set of individuals in a public square.

FIG. 2 is a schematic representation of a map of the three-dimensional envelopes of certain individuals of the group of FIG. 1.

FIG. 3 is a schematic representation of a map of the three-dimensional envelopes of FIG. 2 from a lateral viewpoint.

FIG. 4 is a detailed schematic representation of group III of the three-dimensional envelopes of FIG. 3.

FIG. 5 is a flowchart of a method according to the first aspect of the invention.

FIG. 6 is a schematic representation of a first geometric transformation of a three-dimensional envelope according to one embodiment.

FIG. 7 is a schematic representation of a second geometric transformation of a three-dimensional envelope according to one embodiment.

FIG. 8 is a schematic representation of the result of the second geometric transformation illustrated in FIG. 7.

FIG. 9 is a schematic representation of a third geometric transformation of a three-dimensional envelope according to one embodiment.

FIG. 10 is a schematic representation of a map of three-dimensional envelopes of objects that was obtained from the map of FIG. 3 after applying a method according to the first aspect of the invention.

FIG. 11 is a schematic representation of a data-processing device according to the second aspect of the invention.

### DETAILED DESCRIPTION OF EMBODIMENTS

In the context of the present invention, the expression “monocular image of at least one object” should be understood to mean an image, such as a photograph or a video extract, obtained using a monocular device and in which a scene containing at least one object (such as a human individual, an animal or a vehicle) is shown. The image may represent a plurality of objects of the same or a different nature. Preferably, the image is a perspective image, i.e. the objects are located at various depths of field.

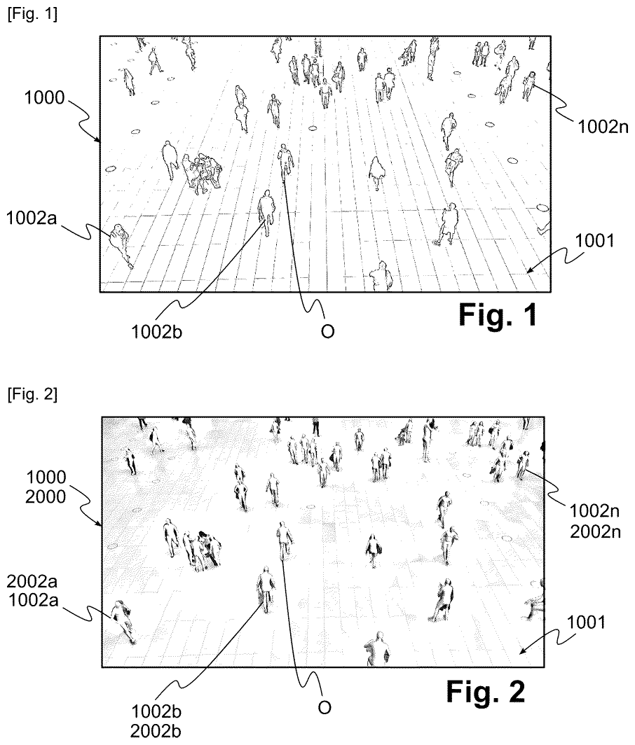

With reference to FIG. 1, one example of a monocular image representing a scene containing at least one object may be the monocular image 1000 of a crowd of individuals 1002a-n moving about in a public square 1001. The image may be taken by a monocular surveillance video camera or a still camera (not shown).

Extraction of a three-dimensional envelope, also called a three-dimensional model or “avatar”, of an object such as an individual from a monocular image is a common operation. In the context of the invention, this extraction may be carried out by means of any suitable method. Examples of extracting methods are detailed in the articles Kocabas, Muhammed, et al. (2021), “SPEC: Seeing people in the wild with an estimated camera”, Proceedings of the IEEE/CVF International Conference on Computer Vision; Li, Zhihao, et al., (2022), “Cliff: Carrying location information in full frames into human pose and shape estimation”, European Conference on Computer Vision. Cham: Springer Nature Switzerland; and Sun, Yu, et al. (2022), “Putting people in their place: Monocular regression of 3D people in depth”, Proceedings of the IEEE/CVF Conference on Computer Vision and Pattern Recognition.

With reference to FIG. 2, an extracting method such as the one described in Li, Zhihao, et al., (2022), “Cliff: Carrying location information in full frames into human pose and shape estimation”, European Conference on Computer Vision. Cham: Springer Nature Switzerland, allows a three-dimensional envelope 2002a-n to be extracted for each of the individuals 1001a-n detected in the monocular image 1001 of FIG. 1. In FIG. 2, the set of three-dimensional envelopes 2002a-n together form a map 2000 superposed on the original image 1001, the three-dimensional envelopes 2002a-n being superposed on the individuals 1001a-n. The map of the three-dimensional envelopes 2002a-n generally features only the models 2002a-n, the floor 1001 not featuring therein.

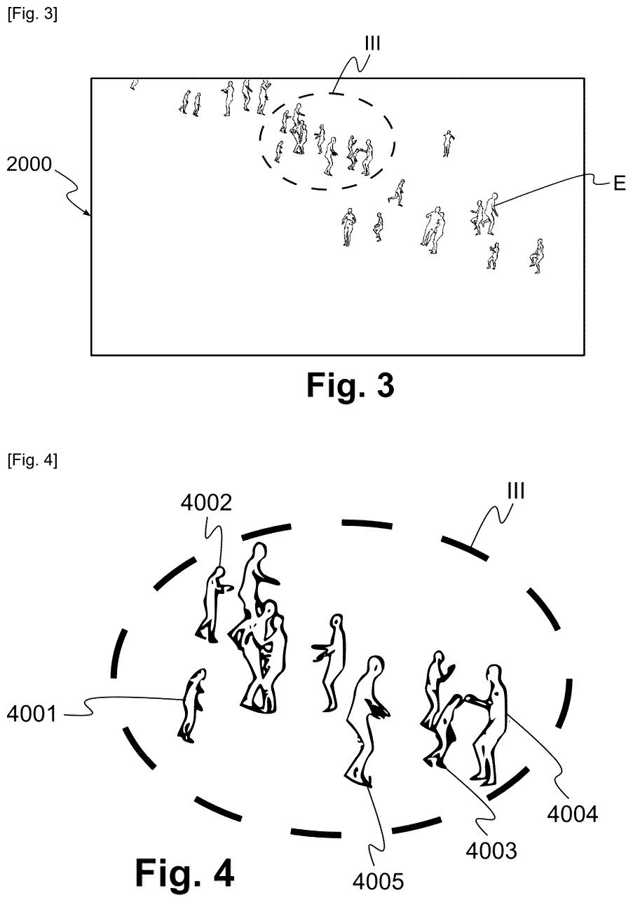

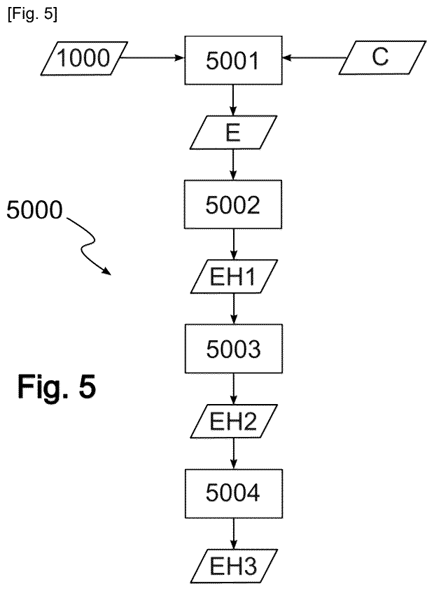

From the map 2000 of the three-dimensional envelopes 2002a-n of the individuals 1001a-n, various viewpoints of the scene of FIG. 1 may be simulated by modifying the perspective or initial position of the camera. By way of example, with reference to FIG. 3, by fictitiously modifying the position of the camera (not shown) so as to make it trace an arc (so-called arc shot) from its initial position in FIG. 2, it is possible to construct a representation of the scene from a lateral viewpoint in which the three-dimensional envelopes 2002a-n are seen from the side.

However, as explained above and illustrated in FIG. 3, the current methods of the prior art fail not only to reposition the three-dimensional envelopes on the floor but also to resize them correctly according to the rules of perspective as a function of the new position of the camera. In FIG. 3, the three-dimensional envelopes do not occupy a natural position. They are not aligned in an oblique direction corresponding to the reference plane of the floor 1001 of FIG. 1. On the contrary, they “float” in the air and are randomly distributed in compact groups in multiple oblique directions. Furthermore, the geometric dimensions of the adjacent three-dimensional envelopes are completely heterogeneous. Specifically, with reference to FIG. 4, in which group III of FIG. 3 is shown in detail, certain three-dimensional envelopes 4001, 4002, 4003 have geometric dimensions much smaller than those of other three-dimensional envelopes 4004, 4005, whereas they should have relatively similar dimensions for a given category of individuals (children, adults, men, women, etc.).

With reference to FIGS. 1, 2, 3 & 5-10, according to a first aspect of the invention, a computer-implemented method 5000 is provided for reconstructing the three-dimensional envelope of an object O from a monocular image 1000, the method taking, as input data, a monocular image 1000 of at least one object O in a scene and the position C, in the real-world reference frame, of the optical center of the camera 6001 representative of the optical device for acquiring said monocular image 1000, and providing, as output datum, a three-dimensional envelope of said object O in said scene, the method comprising the following steps:
(a) providing 5001 a trial three-dimensional envelope E of the object O by processing the monocular image 1000;
(b) obtaining 5002 a first modified three-dimensional envelope EH1 by applying, to the trial three-dimensional envelope E, a first geometric transformation such that a point P1 representative of a lower end of the trial three-dimensional envelope E is contained in a pre-defined first reference plane P corresponding to a floor;
(c) obtaining 5003 a second modified three-dimensional envelope EH2 by applying, to the first modified three-dimensional envelope EH1, a second geometric transformation such that a longitudinal plane representative of the object is perpendicular to a second reference plane D, said reference plane D being defined by the position C of the optical center of the camera 6001, the point P1-1 representative of a lower end and a point P2-1 representative of an upper end of the first three-dimensional envelope EH1;
(d) obtaining 5004 a third modified three-dimensional envelope EH3, by applying, to the second modified three-dimensional envelope EH2, a third geometric transformation such that the geometric dimensions of the third modified three-dimensional envelope EH3 projected into the monocular image 1000 correspond to the original dimensions of the object O in the monocular image 1000.

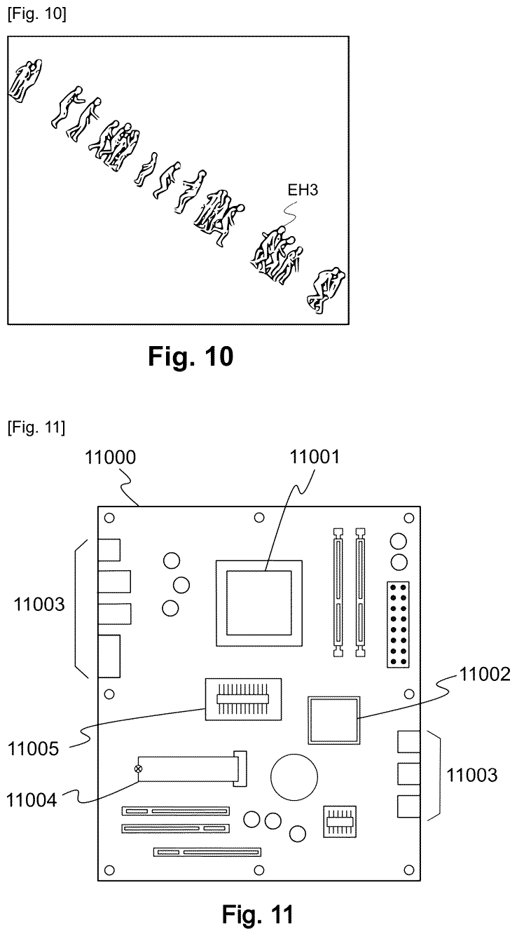

A first noteworthy effect of the invention is that the three-dimensional envelope EH3 of the object remains anchored to the floor, regardless of the viewing angle or viewpoint subsequently chosen to represent the scene. In particular, as illustrated in FIG. 10, compared with FIG. 3, when the method is applied to the objects of a crowd of objects, their three-dimensional envelopes all remain fixed and aligned with an oblique direction corresponding to the reference plane representing the floor 1001 of FIG. 1.

A second noteworthy effect of the invention is preservation of the geometric proportions and orientation of the three-dimensional envelopes in accordance with the distance and with the direction of observation of the camera. Thus, the pose and shape of the three-dimensional envelopes remain representative of those expected when a viewing angle or viewpoint is changed. With reference to FIG. 10, compared with FIG. 3, the dimensions of the adjacent three-dimensional envelopes remain comparable for a given category of individuals.

The invention thus advantageously makes it possible to provide representative and realistic information on the arrangement of the objects, their distribution in the environment, their interactions and their movements in the environment in which they are located. Details otherwise concealed as a result of perspective effects or obstacles may thus be correctly revealed by varying viewing angles.

In the remainder of the description, for the sake of conciseness, details and various embodiments of the method according to the invention are described with respect to the particular case of a monocular image of a scene containing a crowd of human individuals. However, this approach is purely illustrative and it should not be seen as limiting the invention in any way. The method may be applied to a monocular image of a scene containing any type of object such as a human individual, an animal or a vehicle.

In step (a), a trial three-dimensional envelope E of the object O is obtained by processing the monocular image 1000. The processing is image processing of any type suitable for extracting a three-dimensional envelope. Preferably, the trial three-dimensional envelope (E) is obtained using a pre-trained convolutional artificial neural network. By way of examples, it may be a method described in any of the articles cited above, in particular in the article cited in the context of the discussion with reference to FIG. 2.

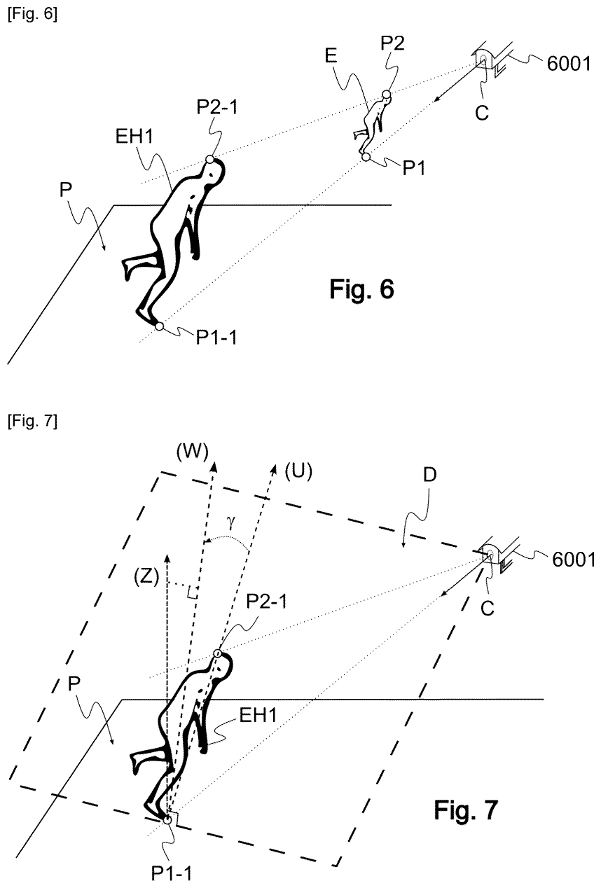

In step (b), with reference to FIG. 6, a first geometric transformation is applied to the trial three-dimensional envelope E such that a point P1 representative of a lower end of the trial three-dimensional envelope E is contained in a pre-defined first reference plane P corresponding to a floor. In FIG. 6, the image point of the representative point P1 is denoted P1-1 and is contained in the reference plane P. The modified three-dimensional envelope after transformation is denoted EH1.

The point P1 representative of a lower end of the object is of any suitable type. Its choice generally depends on the nature and position of the objects. In certain preferred embodiments, when the object is a human individual in an upright position, the lower end of the trial three-dimensional envelope E of the human individual corresponds to the feet of said human individual. The representative point (P1), before transformation, may then be chosen to be the heel, the arch of a foot or a toe of the individual. Alternatively, the lower end may be a lower limb, a lower joint or the buttocks. In this case, since the representative point is selected in a zone higher up the body of the individual, it is preferable to make provision for a compensating distance with respect to the pre-defined first reference plane (P) corresponding to a floor in order to prevent, at the end of the first geometric transformation, all or part of the lower end being located below said reference plane.

The first geometric transformation is of any type suitable for placing the point P1 representative of a lower end of the trial three-dimensional envelope E in a first reference plane P. By way of example, it may be a translation in a direction defined with respect to the viewing angle of the camera 6001 representative of the optical device for acquiring said monocular image 1000. Depending on the distance over which the trial three-dimensional envelope (E) is moved, its size may then be either smaller or larger than the size expected, from the viewpoint of the camera 6001, at the focal length at which the trial three-dimensional envelope (E) is located after movement. The translating operation may then be supplemented by an enlarging or shrinking operation, so that the size of the three-dimensional envelope conforms with the size expected at this distance.

In certain preferred embodiments, the first geometric transformation is a homothety with the position C of the camera as the homothetic center. Such a transformation is advantageous in that it makes it possible to place the point P1 representative of a lower end of the trial three-dimensional envelope E in the first reference plane P while preserving proportions.

In the example illustrated in FIG. 6, the point P1 representative of a lower end of the trial three-dimensional envelope E is moved to an image point P1-1 in the direction CP1, and the point P2 representative of an upper end of the trial three-dimensional envelope E is moved to an image point P2-1 in the direction CP2. The algebraic ratio

$$\frac{\overline{C P 1}}{\overline{C P 1 - 1}} = \frac{\overline{C P 2}}{\overline{C P 2 - 1}}$$

is greater than 1; the modified three-dimensional envelope EH1 is an enlargement of the trial three-dimensional envelope E and its lower end is placed on the reference plane P.

In step (c), with reference to FIGS. 7 & 8, a second geometric transformation is applied to the first modified three-dimensional envelope EH1 such that a longitudinal plane representative of the object is perpendicular to a second reference plane D defined by the position C of the optical center of the camera 6001, the point P1-1 representative of a lower end and a point P2-1 representative of an upper end of the second model EH1. In the example of FIGS. 7 & 8, the longitudinal plane representative of the object perpendicular to the second reference plane D is defined by two directions Z and W starting from the point P1-1, the direction W being contained in the plane D. For a human individual in an upright position, depending on her or his orientation, the longitudinal plane may correspond to the sagittal plane, to the coronal plane or to a plane intermediate between these two planes.

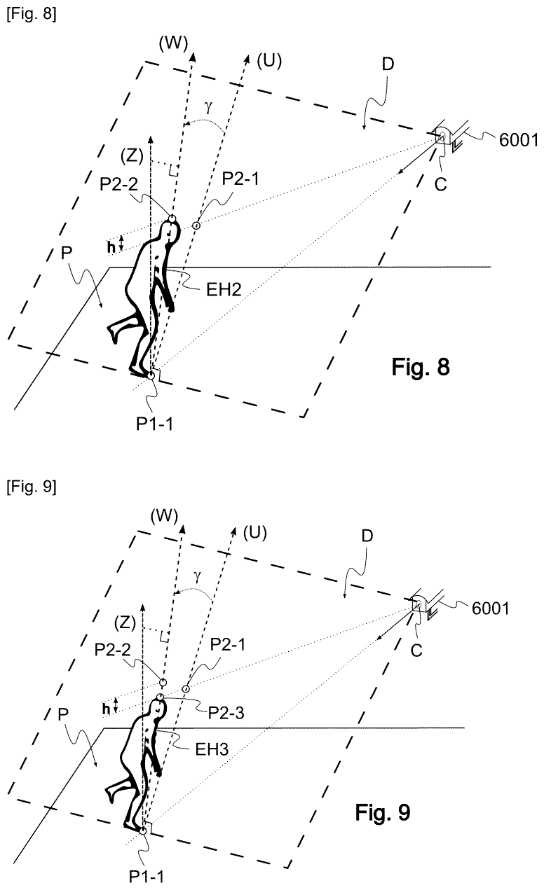

FIG. 7 shows the first modified envelope EH1 before the second geometric transformation. FIG. 8 shows the second modified envelope EH2 after the second geometric transformation has been applied to the first modified envelope EH1.

The point P2-1 representative of an upper end of the first three-dimensional envelope EH1 is of any suitable type. In certain preferred embodiments, the upper part of the first three-dimensional envelope EH1 is selected from the head, neck, shoulders, or chest of the human individual. Preferably, the upper part corresponds to the head and the representative point P2-1 selected lies toward the top of the skull of the individual represented by the first modified three-dimensional envelope (EH1).

In certain preferred embodiments, the second geometric transformation is a rotation having, as center of rotation, the representative point P1-1 of the modified three-dimensional envelope EH1, such that a first direction U representative of a longitudinal direction of the object and a second direction W coincide, the second direction W being an orthogonal projection, in the second reference plane D, of a direction Z orthogonal to the first reference plane P at the point P1-1 representative of the lower part of the first modified envelope EH1. In the example of FIGS. 7 & 8, the first direction U is defined by the points P1-1 and P2-1 representative of the lower part and upper part of the modified three-dimensional envelope EH1, respectively. Alternatively, it may be defined by any other section of points representative of the lower and upper parts of the three-dimensional envelope EH1. In FIGS. 6 & 7, the rotation has been represented by the angle γ between the first direction U and the second direction W. The point P2-2 of the upper part of the modified three-dimensional envelope EH2 is the image of the point P2-1 representative of the upper part of the modified three-dimensional envelope EH1.

In step (d), with reference to FIG. 9, a third geometric transformation is applied to the second modified three-dimensional envelope EH2 such that the geometric dimensions of the third modified three-dimensional envelope EH3 projected into the monocular image 1000 correspond to the original dimensions of the object O in the monocular image 1000. This step has the effect of resizing the three-dimensional envelope in order to compensate for any changes to its dimensions at the end of the second geometric transformation. The size of the three-dimensional envelope then conforms with the size expected in the focal plane of the camera 6001 in which it is located.

In the example in FIG. 8, at the end of the second geometric transformation, the size of the second three-dimensional envelope is larger than it should be at this distance from the camera 6001. This difference in size has been represented by the distance h between the points P2-1 and P2-2. As illustrated in FIG. 9, at the end of the third geometric transformation, the geometric dimensions of the third modified three-dimensional envelope EH3 are smaller than those of the second modified three-dimensional envelope EH2, the representative point P2-2 then having as image the representative point P2-3. The size of the three-dimensional envelope EH3 is thus brought into conformity with the focal length of the camera 6001 at the distance it is from the camera.

In certain preferred embodiments, the third geometric transformation is a homothety with the point P1-1 representative of the lower end of the modified three-dimensional envelope EH3 as homothetic center. The homothety has the advantage of preserving the proportions of the three-dimensional envelope during its resizing.

In the example illustrated in FIG. 9, the point P2-2 representative of the upper end of the second three-dimensional envelope has moved to an image point P2-3 in the direction P1-1P2-2. The algebraic ratio

$$\frac{\overline{P 1 - 1 P 2 - 3}}{\overline{P 1 - 1 P 2 - 2}}$$

is less than 1; the modified three-dimensional envelope EH3 is a reduction of the second modified three-dimensional envelope EH2, and the representative point P2-3 is aligned with the point P1-1 representative of the upper end of the first three-dimensional envelope and the position C of the optical center of the camera 6001.

In step (a), when the trial three-dimensional envelope E of the object O is extracted by processing the monocular image 1000, it is common for the background of the image corresponding to the backdrop of the scene to be deleted. As illustrated in FIG. 3 or FIG. 10, for a crowd of individuals, the result is a map of three-dimensional envelopes of individuals on a neutral background.

In certain embodiments, the method further comprises a step of adding a background selected from: a background corresponding to the background of the scene of the original monocular image; and an artificial background. Adding a background corresponding to the background of the scene of the original monocular image allows the three-dimensional envelopes to be put back into the context of the scene of the original monocular image. It is thus possible to provide additional information on potential interactions of individuals with other stationary or moving objects of the scene or on their position relative to particular geographical areas of the scene. In contrast, adding an artificial background, such as a neutral landscape or a simple square, may advantageously allow the confidentiality of the facilities of the scene to be preserved. For example, in a private place, such as a company, maintaining the confidentiality of the facilities may be essential to avoid disclosure of certain know-how or trade secrets.

In certain embodiments, the method further comprises a step of texturing the modified three-dimensional envelope EH3 of the object O. This additional step may be particularly advantageous when the object is an individual and it is necessary to protect her or his identity by preventing certain of the individual's biometric characteristics that enable them to be identified from being revealed. For example, in the context of a study, a model and a prediction of collective behavior during movements of a crowd of individuals, the identity of the individuals in the crowd is generally not a relevant datum. It is therefore recommendable to protect their identity by texturing the three-dimensional envelopes of the individuals. Likewise, in the context of a police investigation, it may be advantageous to protect the identity of individuals in a crowd who have no relevant connection to the investigation.

In certain embodiments, the method further comprises at least one step of changing perspective or viewing angle. Since the method according to the invention allows a realistic representation of the arrangement of objects in the environment of a scene to be obtained, a change of perspective or viewing angle may advantageously allow a better understanding of interactions between the objects to be achieved and elements of the scene that would otherwise be concealed to be revealed. In particular, in the case where the object is a human individual, such a change may reveal the way in which she or he interacts with her or his environment.

As underlined above, the method according to the invention may be applied to a monocular image representing a scene in which any type of object is located. In certain advantageous modes of use, the method according to the invention may be employed to reconstruct a three-dimensional image of a plurality of human individuals in a public or private place. It thus allows the scene to be studied to precisely examine the distribution of individuals in space and their relationships.

The method according to the first aspect of the invention is computer-implemented. With reference to FIG. 11, according to a second aspect of the invention, a data-processing device 11000 comprising means for implementing a method according to any one of the embodiments of the first aspect of the invention is provided.

The data-processing device 11000, which is referred to generally as the computer, may be tasked with automatically executing sequences of arithmetic or logic operations with a view to performing tasks or actions. It may comprise one or more central processing units (CPUs) 11001 and/or one or more graphic processing units (GPUs) 11002 and a device 11005 allowing communication between these units and the other components of the device. It may also comprise other electronic components such as input/output interfaces 11003, non-volatile or volatile storage devices 11004, and communication buses for transferring data between the internal components of the device or with external components. One of the input/output devices 11003 may be a connection interface of a human-machine interaction device, in particular a graphical user interface such as a screen for displaying humanly understandable information and/or sending data and/or instructions to the data-processing device 11000.

According to a third aspect of the invention, a computer program comprising instructions that, when the program is executed by a computer, cause the latter to implement a method according to any one of the embodiments of the first aspect of the invention is provided.

Any type of compiled or interpreted programming language may be used to implement the steps of the method of the invention. The computer program may form part of a software solution, that is to say a collection of executable instructions, codes, scripts or the like and/or databases.

According to a fourth aspect of the invention, a computer-readable recording medium 11004 comprising instructions that, when they are executed by a computer, cause the latter to implement a method according to any one of the embodiments of the first aspect of the invention is provided.

The computer-readable recording medium 11004 is preferably a non-volatile memory, for example a hard disk or a semiconductor-based reader. It may be a removable storage medium or a non-removable storage medium forming part of a computer. The computer-readable recording medium 11004 may also be a volatile memory inside a removable medium. This may facilitate the deployment of the invention in numerous production sites.

The computer-readable recording medium 11004 may form part of a computer used as a server from which executable instructions may be downloaded which, when they are executed by a computer, cause the computer to execute a method according to one of the embodiments described in the present document.

The computer program and the medium 11004 on which it is recorded may be implemented in a distributed computing environment, for example in the cloud. The instructions may be executed on a server to which one or more client computers may connect and provide data encoded as input data for a method according to any one of the embodiments of the first aspect of the invention. Once the data have been processed, the result may be downloaded onto and decoded on the client computer or be sent directly, for example, in the form of instructions.

According to a third aspect of the invention, a system for reconstructing the three-dimensional shape EH3 of an object O from a binocular image 10000 is provided. The system comprises:
an optical device for acquiring a monocular image 1000;
a data-processing device 11004 according to the second aspect of the invention, configured to receive a monocular image 1000 acquired by said optical acquiring device.

The optical device for acquiring a monocular image is of any suitable type. It may be a monocular video camera or still camera, in particular a monocular video camera for surveillance of a public or private place. In the latter case, the system may advantageously be used to reconstruct a three-dimensional image of a plurality of human individuals moving through a public or private place.

### REFERENCES

### Non-Patent Literature

Kocabas, Muhammed, et al. (2021), “SPEC: Seeing people in the wild with an estimated camera”, Proceedings of the IEEE/CVF International Conference on Computer Vision.
Li, Zhihao, et al., (2022), “Cliff: Carrying location information in full frames into human pose and shape estimation”, European Conference on Computer Vision. Cham: Springer Nature Switzerland.
Sun, Yu, et al. (2022), “Putting people in their place: Monocular regression of 3D people in depth”, Proceedings of the IEEE/CVF Conference on Computer Vision and Pattern Recognition.

1. A computer-implemented method for reconstructing a three-dimensional envelope of an object from a monocular image, the method comprising:
providing a trial three-dimensional envelope of an object by processing a monocular image of the object in a scene and a position, in a real-world reference frame, of an optical center of a camera representative of an optical device for acquiring said monocular image, the monocular image being taken as input data;
obtaining a first modified three-dimensional envelope by applying, to the trial three-dimensional envelope, a first geometric transformation such that a first point representative of a lower end of the trial three-dimensional envelope is contained in a pre-defined first reference plane corresponding to a floor;
obtaining a second modified three-dimensional envelope by applying, to the first modified three-dimensional envelope, a second geometric transformation such that a longitudinal plane representative of the object is perpendicular to a second reference plane, said second reference plane being defined by the position of the optical center of the camera, the first point representative of a lower end and a second point representative of an upper end of the first modified three-dimensional envelope;
obtaining a third modified three-dimensional envelope, by applying, to the second modified three-dimensional envelope, a third geometric transformation such that geometric dimensions of the third modified three-dimensional envelope projected into the monocular image correspond to the original dimensions of the object in the monocular image; and
providing, as output datum, the three-dimensional envelope of said object in said scene.

2. The method as claimed in claim 1, wherein the first geometric transformation is a homothety with the position of the camera as the homothetic center.

3. The method as claimed in claim 1, wherein the second geometric transformation is a rotation having, as center of rotation, the first point of the modified three-dimensional envelope, such that a first direction representative of a longitudinal direction of the object and a second direction coincide, the second direction being an orthogonal projection, in the second reference plane, of a direction orthogonal to the first reference plane at the first point representative of the lower part of the first modified three-dimensional envelope.

4. The method as claimed in claim 1, wherein the third geometric transformation is a homothety with the first point representative of the lower end of the modified three-dimensional envelope as homothetic center.

5. The method as claimed in claim 1, wherein the object is a human individual in an upright position and the lower end of the trial three-dimensional envelope of the human individual corresponds to the feet of said human individual.

6. The method as claimed in claim 5, wherein an upper part of the first modified three-dimensional envelope is selected from the head, neck, shoulders, or chest of the human individual.

7. The method as claimed in claim 1, wherein the trial three-dimensional envelope of the object is obtained using a pre-trained convolutional artificial neural network.

8. The method as claimed in claim 1, further comprising adding a background selected from: a background corresponding to the background of the scene of the original monocular image and an artificial background.

9. The method as claimed in claim 1, further comprising texturing the modified three-dimensional envelope of the object.

10. The method as claimed in claim 1, further comprising changing perspective or viewing angle.

11. (canceled)

12. A data-processing device for reconstructing a three-dimensional envelope of an object from a monocular image comprising:
processing circuitry configured to:
provide a trial three-dimensional envelope of an object by processing a monocular image of the object in a scene and a position, in a real-world reference frame, of an optical center of a camera representative of an optical device for acquiring said monocular image, the monocular image being taken as input data,
obtain a first modified three-dimensional envelope by applying, to the trial three-dimensional envelope, a first geometric transformation such that a first point representative of a lower end of the trial three-dimensional envelope is contained in a pre-defined first reference plane corresponding to a floor,
obtain a second modified three-dimensional envelope by applying, to the first modified three-dimensional envelope, a second geometric transformation such that a longitudinal plane representative of the object is perpendicular to a second reference plane, said second reference plane being defined by the position of the optical center of the camera, the first point representative of a lower end and a second point representative of an upper end of the first modified three-dimensional envelope,
obtain a third modified three-dimensional envelope, by applying, to the second modified three-dimensional envelope, a third geometric transformation such that geometric dimensions of the third modified three-dimensional envelope projected into the monocular image correspond to the original dimensions of the object in the monocular image, and
provide, as output datum, the three-dimensional envelope of said object in said scene.

13. (canceled)

14. A non-transitory computer-readable storage medium having instructions that, when they are executed by a computer, causes the computer to implement the method as claimed in claim 1.

15. A system for reconstructing a three-dimensional shape of an object from a monocular image, said system comprising:
an optical device for acquiring a monocular image;
the data-processing device as claimed in claim 12, configured to receive a monocular image acquired by said optical device.

16. The method as claimed in claim 2, wherein the second geometric transformation is a rotation having, as center of rotation, the first point of the modified three-dimensional envelope, such that a first direction representative of a longitudinal direction of the object and a second direction coincide, the second direction being an orthogonal projection, in the second reference plane, of a direction orthogonal to the first reference plane at the first point representative of the lower part of the first three-dimensional modified envelope.

17. The method as claimed in claim 2, wherein the third geometric transformation is a homothety with the first point representative of the lower end of the modified three-dimensional envelope as homothetic center.

18. The method as claimed in claim 3, wherein the third geometric transformation is a homothety with the first point representative of the lower end of the modified three-dimensional envelope as homothetic center.

19. The method as claimed in claim 2, wherein the object is a human individual in an upright position and the lower end of the trial three-dimensional envelope of the human individual corresponds to the feet of said human individual.

20. The method as claimed in claim 3, wherein the object is a human individual in an upright position and the lower end of the trial three-dimensional envelope of the human individual corresponds to the feet of said human individual.

21. The method as claimed in claim 4, wherein the object is a human individual in an upright position and the lower end of the trial three-dimensional envelope of the human individual corresponds to the feet of said human individual.

22. The method as claimed in claim 2, wherein the trial three-dimensional envelope of the object is obtained using a pre-trained convolutional artificial neural network.
